(19) United States
(12) Patent Application Publication
(10) Pub. No.: US 2008/0110973 A1
(43) Pub. Date: May 15, 2008

(54) SYSTEM AND METHOD OF CREDIT DATA COLLECTION AND VERIFICATION

(76) Inventors: Michael G. Nathans, Annapolis, MD (US); Marcia A. Goldstein-Nathans, Annapolis, MD (US); Kevin E. Goldstein, Annapolis, MD (US); Matthew B. Vitko, Annapolis, MD (US)

Correspondence Address: DLA PIPER US LLP;ATTN: PATENT GROUP, 500 8th Street, NW, WASHINGTON, DC, 20004-2131, US

(21) Appl. No.: 11/847,853

(22) Filed: Aug. 30, 2007

Related U.S. Application Data
(60) Provisional application No. 60/824,020, filed on Aug. 30, 2006.

(51) Int. Cl. G07F 19/00; G06Q 40/00

(52) U.S. Cl. 235/379; 705/35; 705/38

(57) ABSTRACT

A system and method for verifying a stream of payments includes accepting a request for verification and, optionally, supporting documentation relating to the payments from a user such as a consumer and transmitting the request and the supporting documentation to a verifier who is unknown to the consumer at the time the request is made. The verifier directly contacts the payee to verify the payment stream. If the verifier indicates that the payment stream has been verified, the consumer is notified and given the opportunity to designate a third party recipient to whom the verification will be sent.

### CROSS REFERENCE TO RELATED APPLICATIONS

This application is based on, and claims priority to, U.S. Provisional Application Ser. No. 60/824,020, filed Aug. 30, 2006, the entire contents of which are hereby incorporated by reference.

### BACKGROUND

Traditionally, credit-worthiness is calculated based on credit payment data collected from creditors using automated methods. Traditional credit bureaus use this credit payment data to automatically calculate FICO (Fair, Isaac & Co.) credit scores for their subscribers using FICO's proprietary algorithms. These FICO credit scores are in turn used by automated underwriting and credit application scoring models to determine the risk of default and credit pricing. The FICO credit scores often ultimately determine whether the applicant will qualify for the credit sought.

Distinct social and racial disparities associated with this other-wise effective traditional automated underwriting credit risk management technology have been observed, especially in connection with low and moderate income consumers, first-time homebuyers, and consumers with rehabilitated credit. In order to qualify for credit, such consumers must establish credit-worthiness using the traditional credit instruments and payment history collection and reporting practices. However, the traditional methods used to establish credit-worthiness present distinct unfair disadvantages, especially to fiscally responsible low- and moderate-income consumers who pay their residential rent or mortgage, utilities, phone, retail credit bills on time, but whose on-time payments for these obligations have not been reported to a credit bureau.

A significant cause of this problem is that many smaller creditors and non-traditional creditors such as apartment rental landlords, small private mortgage lenders, buy-here-pay-here auto finance dealers, utility, day care and telephone service providers do not report to traditional credit bureaus because of technical barriers, lack of convenience, or, in the case of unscrupulous lenders, a desire to keep good paying consumers from qualifying for credit on better terms from other lenders. This results in many borrowers that faithfully pay on time not receiving recognition for such payments by automated credit underwriting technologies that rely on automated payment data from the credit bureaus. Thus, the FICO scores generated for such low- and moderate-income consumers who do not have traditional lines of credit, do not own their own homes, and/or whose mortgage payments are not reported are based solely on traditional credit history (which is defined as credit for retail goods and services such as auto loans or credit cards). The resulting FICO scores are therefore either non-existent or lower than they should be, resulting in higher cost of credit or inability to obtain credit for such consumers.

Furthermore, FICO scores that are based solely on traditional credit information, and that do not take into account housing payments, are not as accurate in predicting the likelihood of default on a residential mortgage or lease as a credit score in which housing credit data (if electronically accessible) is assessed. This is because the correlation between an applicant's past housing credit payment behavior and their future housing credit payment behavior is believed to be a stronger (and thus a more accurate indication of probability of default) than the correlation between past retail credit only payment behavior and future housing credit payment behavior.

Further, consideration of non-traditional credit payments has only been by mortgage lenders willing to do the time consuming and cumbersome work associated with collecting and verifying an applicant's paper documentation. However, current methods of performing such verifications do not have sufficient safeguards to ensure that the verifications are accurately performed, the verified data is not stored in a credit bureau where it can be accessed for “permissible purposes” under the Fair Credit Reporting Act, and the data is not scored.

Therefore, there is a need to improve the data collection and verification process to separate consumers from the third party verifier, thus removing the appearance of a conflict or actual conflict of interest and data integrity issues arising from the possibility of a consumer influencing the verifier with money in order to obtain a favorable report, and for storing and scoring the data for future use when a credit report on the consumer is needed.

### BRIEF DESCRIPTION OF THE DRAWINGS

The following detailed description may be understood with reference to the following figures in which:

FIG. 1 is a block diagram of a payment data collection and verification system according to one embodiment.

FIGS. 2a and 2b is a flowchart showing operation of the system of FIG. 1.

FIG. 3 is a first screen shot showing a screen displayed to a consumer by the system of FIG. 1.

FIG. 4 is a second screen shot showing a screen displayed to a user by the system of FIG. 1.

FIG. 5 is a third screen shot showing a screen displayed to a user by the system of FIG. 1.

FIG. 6 is a fourth screen shot showing a screen displayed to a user by the system of FIG. 1.

FIG. 7 is a fifth screen shot showing a screen displayed to a user by the system of FIG. 1.

### DETAILED DESCRIPTION OF SEVERAL EMBODIMENTS

In the following detailed description, a plurality of specific details, such as communication methods and web site screen shots, are set forth in order to provide a thorough understanding of the embodiments discussed below. The details discussed in connection with these embodiments should not be understood to limit the present invention. Furthermore, for ease of understanding, certain method steps are delineated as separate steps; however, these steps should not be construed as necessarily distinct nor order dependent in their performance.

Various embodiments provide the opportunity for users such as consumers who have made payments to entities such as creditors (or other entities to whom payments were due) that do not report credit data to provide evidence of such payments to a payment data repository. If the evidence of the payments is verified, a report based on the verified payment data is then made available to third parties such as credit providers to whom the consumer has authorized release of the information. In some embodiments, the report comprises a score based on the payment data (including amount and date of the payment) and information concerning the underlying obligation (including the date on which the payments were due and the amount due on such dates). In other embodiments, the report includes raw or summarized payment data in place of or in addition to a score.

In one embodiment, a payment reporting and verification method requires consumers to, for example, bring proof of their historical payments to a local trusted third party such as a certified public account, lawyer, or non-profit entity, who serves as a verifier. The verified information is then stored in a credit repository and made available to third party credit providers.

However, while such methods of payment reporting and verifications discussed above are useful, they are not ideal in that there are minimal safeguards to ensure that the verifications are effectively and accurately carried out by the trusted third party. That is, the contact between the third party verifier or a party associated with the third party verifier and the consumer at the time the verifier is engaged to perform the verification creates the potential for compromised integrity of the verification process. For example, consider a scenario in which a consumer wishes to obtain a mortgage in connection with the purchase of a home. If the mortgage broker, or an attorney, accountant or other person associated in some way with the mortgage broker (e.g., an attorney who will handle the closing or to whom the mortgage broker provides work) performs the verification process, there may be a motivation for the verifier to compromise the integrity of the verification process.

In other embodiments, direct contact between the consumer and the verifier is prevented entirely, or at least until after the time in which the verifier is assigned to perform the verification process. This significantly enhances the integrity of the verification process by removing the appearance of a conflict of interest and decreasing the potential for a consumer to influence the verifier to issue a good report with money or other incentives. The consumer posts the payment information to a credit repository website, orders a verification that is paid for using the web site, and is then given instructions to send proof of payment documents to the credit repository. The verification order is assigned to a verifier who then views the payment information on the repository website and obtains the documents from the repository for manual verification. In some embodiments, the verification procedures require the verifier to contact the creditor or service provider who received the past payments directly in addition to looking at the consumer's web site entries and proof of payment documents (if any).

In an embodiment, a payment data collection and verification system and method is provided to require predetermined verifiers to contact authorized credit or service providers directly in addition to looking at the consumer's proof of payment. A payment data collection and verification system and method is also provided that requires consumers and small businesses (with a Federal Employer Identification Number) to submit an authorization form that permits an authorized credit or service providers to release the consumer's or small businesses' information to a predetermined verifier. The payment data collection and verification system and method is configured such that verification orders are outsourced to an independent entity that is separate and autonomous from the consumers, small businesses, and system providing the credit payment data collection and verification service. This improvement also helps remove the appearance of a conflict of interest and data integrity issues.

Therefore, the present payment data collection and verification system and method provides a forum for consumers and small businesses to report voluntarily their historical monthly payments to a credit bureau subject to third party verification, and thus, build a consumer credit file and score that must be considered under Section 202.6 of the Equal Credit Opportunity Act whenever a credit bureau report is used to assess their credit worthiness.

The embodiments of the present payment data collection and verification system and method solve problems encountered by consumers when information relating to positive payment is not reported. The consequence of the non-reporting of positive payments by a third party is that the consumers may receive adverse feedback when they apply for housing, credit, insurance, utility hook-ups, telecom service, and/or employment. Further, consumers who pay their regular bills on time such as rent, utilities, phone, and insurance, but who have chosen not to use so-called traditional forms of credit to live beyond their means may be adversely affected because of their correspondingly low credit scores. While this category of consumers are fiscally responsible and otherwise good credit risks, these consumers often have little or no payment histories with credit bureaus. Ironically, having no positive or negative credit history in one or more of the traditional credit bureaus has the same effect as having bad credit when a traditional report and score are used to assess an applicant.

Therefore, an embodiment of the present invention provides a system and method for payment data collection and verification that allows consumers and business owners to self enroll to create a consumer or separate business credit file, to self-report prior payments within a predetermined time period, to order and pay for a verification of self-reported payments on line by electronic means, and to build a credit file and score as a result of the above-mentioned verification.

As a consequence, consumers who previously defaulted on their credit but who are currently rehabilitated and have paid their bills consistently on time for a reasonably long period of time, are able to receive positive credit reporting. Further, consumers whose past credit problems are a result of circumstances beyond their control such as illness, loss of employment, or divorce are likely to receive credit reports and scores that reflect their current consistent payments. These consumers are then able to show they have paid their bills on time, and thus, are capable of recovering from prior events beyond their control or past financial management mistakes.

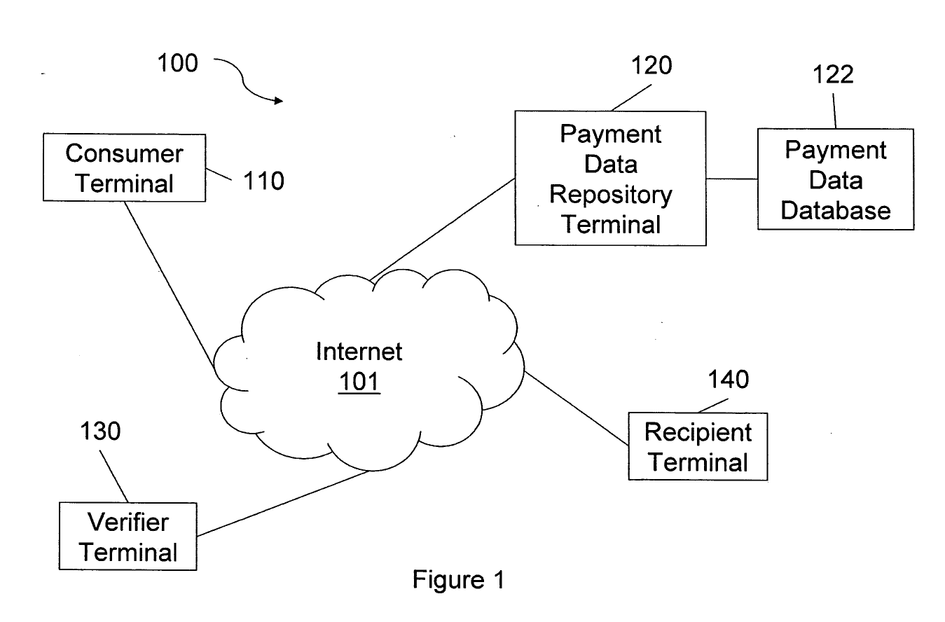

An example of a system 100 for collecting and verifying payment data is illustrated in FIG. 1. The system 100 includes a user terminal 110. (As used herein, “terminal” refers to a data processing device such as a personal computer, a server, a workstation, a mainframe, or any other type of device that is capable of processing data, or a “dumb” terminal connected to such a device). The user terminal 110 is used by a user wishing to have a stream of payments verified to communicate with a payment data processing terminal 120 via a network such as the Internet 101. The communications with the payment data processing terminal 120 include registration data and payment data and, in some embodiments, an authorization authorizing the release of verification data pertaining to the payments by the party to whom the payment was made to a third party verifier. The payment data processing terminal 120 has a payment data database 122 connected to it for storing payment data and, in some embodiments, credit term data. (As used herein, “database” is not limited to relational databases but rather is broadly used to refer to any collection of data). The payment database preferably includes non-volatile memory. Payment data preferably includes an amount of a payment and a date on which the payment was made, and an identifier associated with the payment that identifies the payee. The payment data may also include an account number associated with the payment.

Also connected to the payment data processing terminal 120 is a verifier terminal 130. The verifier terminal 130 is used by a verifier to receive payment data to be verified from the payment data repository terminal 120 and to transmit a verification back to the payment data repository terminal 120. Finally, a recipient terminal 140 is also connected to the payment data repository terminal 120 via the Internet 101. The recipient terminal 140 receives verified payment data and/or a credit score from the payment data processing terminal 120.

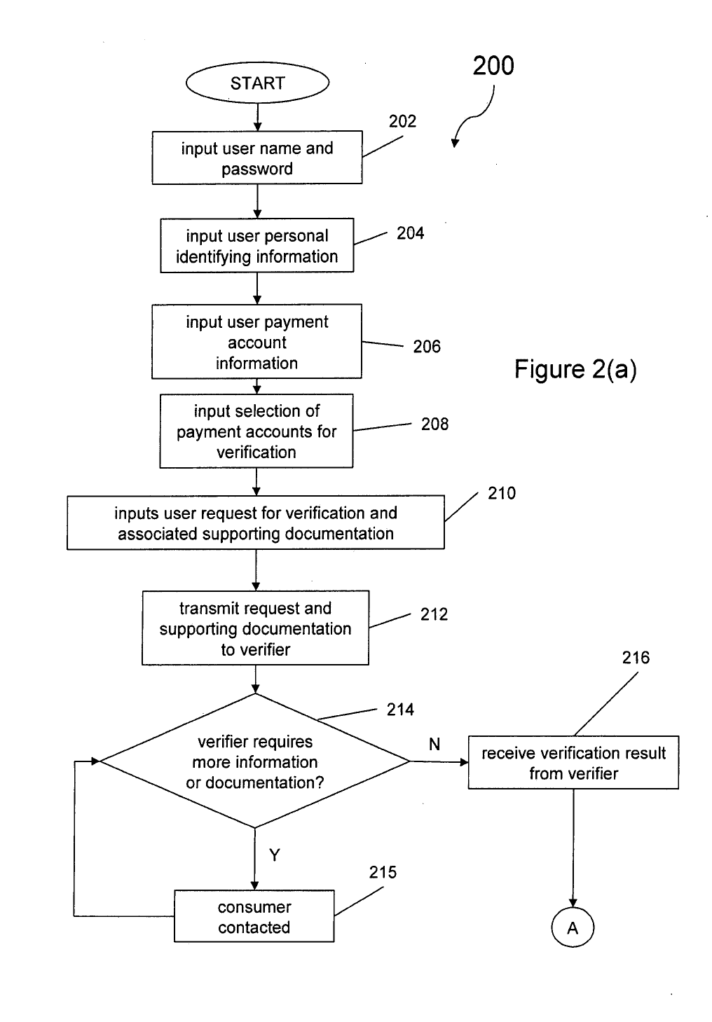

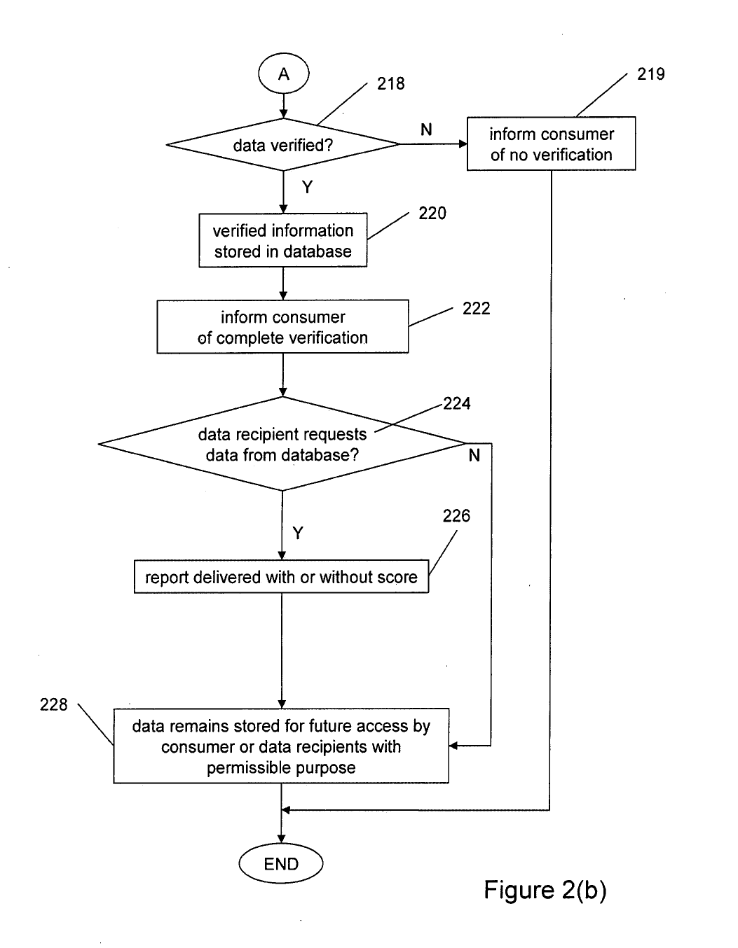

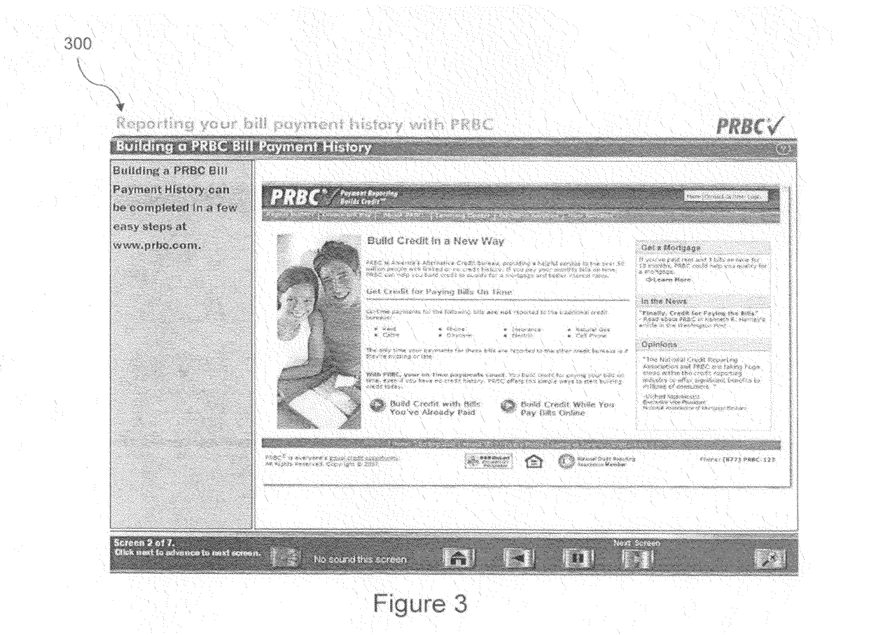

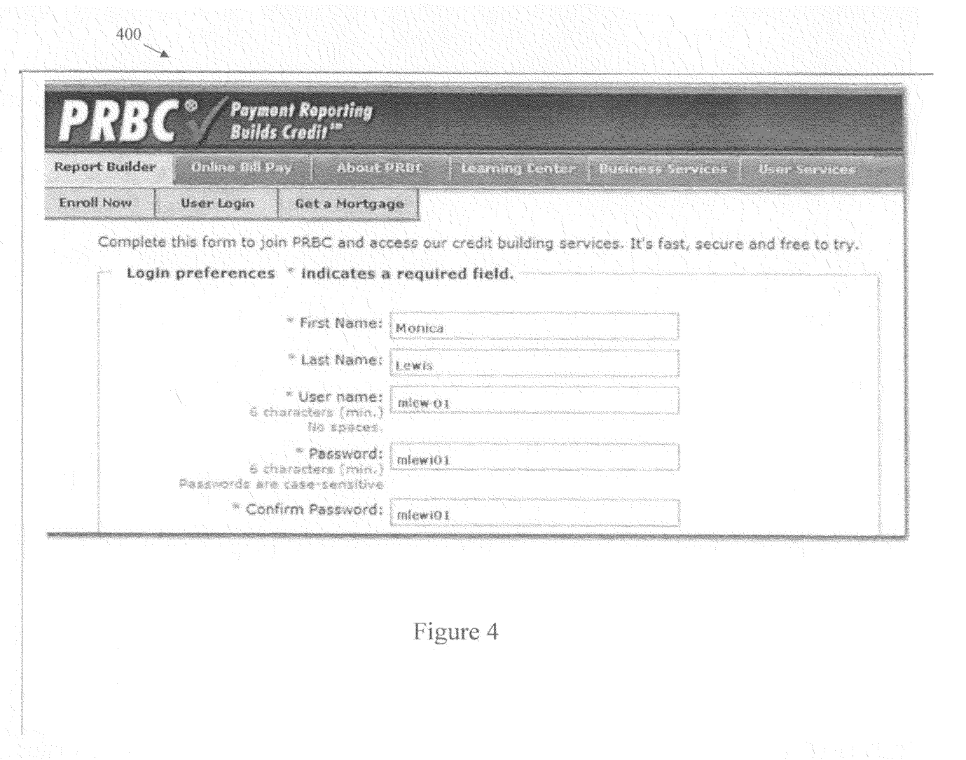

Operation of the system 100 will now be explained with reference to the flowchart 200 of FIGS. 2(a) and 2(b). The method begins when the payment data repository terminal 120 receives a request from a user for participation in the verification process. The request may come in any manner, including by the user pressing an icon 310 on a webpage served by the payment data repository terminal 120 as shown in the screenshot 300 of FIG. 3. Assuming the user is a new user, the payment data repository terminal 120 inputs account set up information at step 202. The account information can include a username and a password as shown in the screenshot 400 of FIG. 4. The use of a password ensures that only the user can access the account, thereby ensuring that the user has control of the data. Those of skill in the art will recognize that other forms of security, such as biometric data, may be used in lieu of or in addition to the password for security purposes.

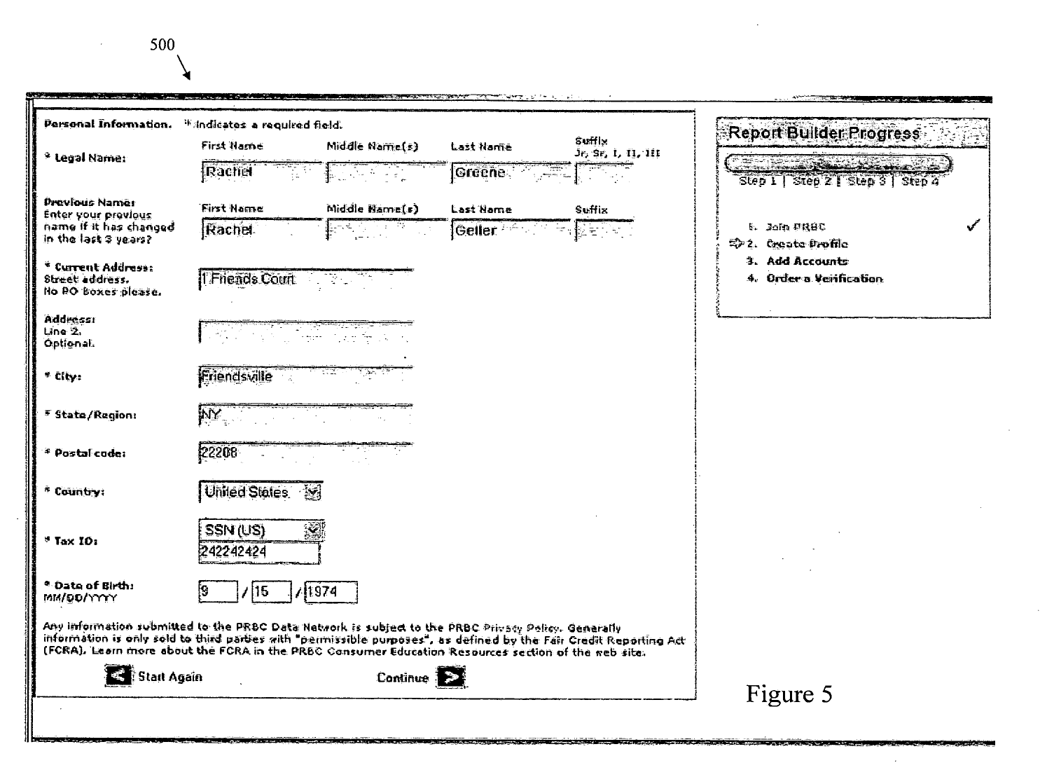

Next, the user inputs personal identifying information at step 204. As shown in the screenshot 500 of FIG. 5, this information can include previous and/or other names by which the user has been known, an address for the user, a date of birth for the user, and a date of birth for the user. It should be understood that steps 202 and 204 may be skipped for a previously-registered user.

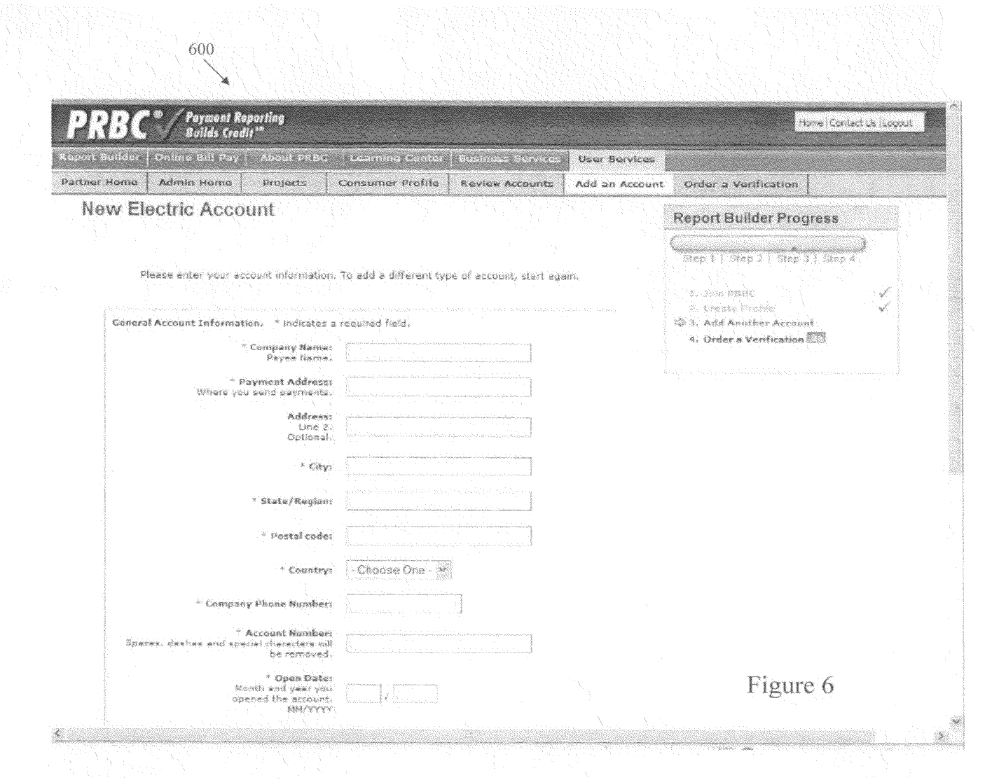

The payment data repository terminal 120 then inputs payment account information corresponding to a stream of payments to be verified at step 206. The account data can include the payee's name and address, the address to which the payments are sent if different from the payee's address, the user's account number, and a date on which the account was opened. In some embodiments, the account data also includes the date and amounts of payments that are due from the user. Other appropriate data that may be useful for verifying payment data may also be included. An exemplary screen shot 600 of a web page for entering such account information is illustrated in FIG. 6.

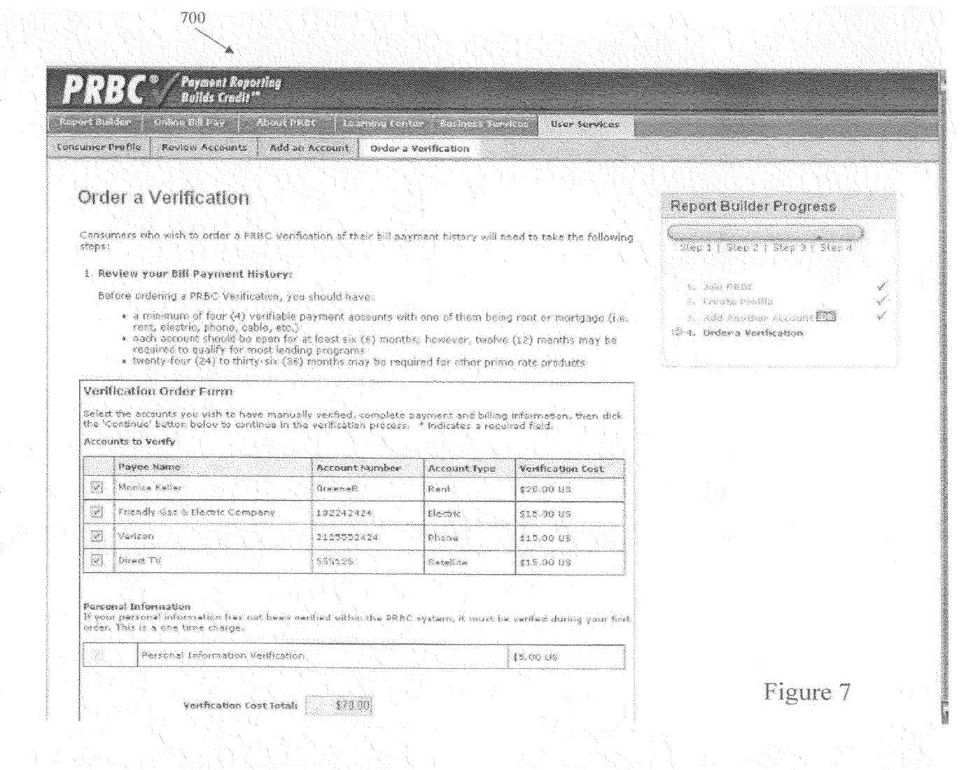

Once information for at least one account has been input at step 206, the payment data repository terminal 120 receives from the user a selection of one or more accounts to be verified at step 208. An exemplary screen shot 700 illustrating a mechanism for making such a selection is shown in FIG. 7. In some embodiments, the web page includes an authorization form that must be completed by the user. The authorization authorizes the payee to release information concerning the payments to be verified to the verifier. The user then requests verification for the selected account(s) at step 210. In some embodiments, the request is accompanied by supporting documentation and the web page includes provisions for facilitating the input of such supporting documentation from the user. In other embodiments, the supporting documentation (if any) is transmitted to the payment data repository terminal 120 via email or via regular mail and is scanned and uploaded to the payment data repository terminal 120 by associated personnel (it should be understood that supporting documentation from the user is not always available and that the methods and systems discussed herein are not limited to verifying payment streams for which supporting documentation from the user is available).

The request along with any supporting documentation received from the user is then transmitted to a verifier via the verifier terminal 130 at step 212. In some embodiments, the verifier must be a member of the NCRA or be supervised by such a member, or an FCRA-certified specialist. If an indication that the verifier requires more information or documentation is received at step 214, the user is contacted for the additional information at step 215. As discussed above, in some embodiments the user never learns the identity of the verifier, and handling of the aforementioned communications for additional information/documentation through the payment data repository terminal 120 is one method in which the identity of the verifier can be withheld from the user. It should be understood that in other embodiments in which the user is not prohibited from learning an identity of the verifier after the process has begun, the verifier may contact the user directly by phone or mail or via the payment data repository terminal 120, and, in some instances, may set up a conference call with the payee and the user in order to facilitate the release of the payment information by the payee to the user.

An indication of whether or not the payments have been verified is received from the verifier at step 216. In some embodiments, the verification is performed through contact with the payee. In other embodiments, the verification is performed only using paper documentation. If the indication from the verifier indicates that the payments have not been verified at step 218, the payment data repository terminal 120 transmits a message indicating the same to the user at step 219 and the process ends.

If an indication that the payment stream has been verified is received from the verifier at step 218, the indication together with any additional verification information (e.g., the name of an individual at the payee who provided a telephonic verification, any paper documentation received from the payee, the name and/or other identifying information pertaining to the verifier) is stored in the database 122 at step 220. The user is then informed of the verification at step 222.

Typically, a user has requested verification of a payment stream in connection with an application for credit, employment, insurance or some other purpose. In such a situation, the entity to whom such an application has been made will request information concerning the payments. If such a request is received from a third party at step 224, a verification report is output to the third party recipient at step 226. After the verification report has been output, or if no request is received, the payment and verification information remains stored in the payment data database for future use/access by the user or a third party recipient at step 228.

The verification report can take any number of forms. In some embodiments, the report simply includes the date and amount of each payment together with an indication that the payments have been verified. In other embodiments, the report further includes a statement that the payments were made on time and in the correct amount. In yet other embodiments, the report can include a simple statement that X number of payments were made on time and in the correct amount. In still other embodiments in which a score is calculated, the report can include only the score. It should also be understood that, as a practical matter, it may be the case that no supporting documentation is available from the user and the only information available from the payee is an indication of how long the account has been open and an identification of any payments that were received late. In those situations, report provided to the recipient will include the foregoing information. Combinations of any or all of the foregoing are also possible.

In the embodiment discussed above, the user is only asked to designate a third party recipient after the verifier has verified the payment stream. This provides the user with the ability to prevent any report of a failed verification from reaching a third party recipient. Those of skill in the art will recognize that it is also possible to take such an option away from the user by requiring the user to designate a third party recipient at the outset of the verification process and not giving the user an option to halt the report of the verification process to the third party.

In the embodiment discussed above, all of the communications were conducted using various terminals. It should be understood, however, that some or all of the foregoing communications may be affected using other means. For example, the notification to the recipient may be sent using mail or a delivery service or any other means. The same is true for some or all of the communications with the verifier and the user. Thus, for example, in some embodiments, a written authorization form is mailed to the user's address and a signed authorization form from the user is returned by mail instead of accepting an authorization from the user via the user terminal 110.

While the aforementioned systems and methods were discussed primarily in the context of collecting and verifying payments made pursuant to a credit agreement for use in obtaining credit, the invention should not be understood to be so limited. In addition to payments made pursuant to credit agreements such as loans, payment data for items that do involve the extension of credit (e.g., phone bills, cable bills, etc.) may also be collected and verified. Indeed, in the context of consumer bills relating to services such as cable television, it is often a matter of operator preference whether the services are pre-paid or paid after receipt. In such a context, distinguishing between a bill for pre-paid service (which does not involve the extension of credit to the consumer) and a bill for service previously provided (which does involve the extension of credit to the consumer) is not terribly useful. Moreover, the use to which the verified payment data can be made is not limited to applications for additional credit. For example, the verified payment data may be submitted to an insurance company in connection with an automobile insurance policy as some insurance companies have been known to use credit reports as a basis for determining rates. As another example, employers have used credit reports when deciding whether to hire a job applicant. Thus, it should be understood that the collection and verification of any type of payment data for any purpose whatsoever, including “permissible purposes” under the Fair Credit Reporting Act as well as other purposes, is within the scope of the present invention.

Although systems and methods described above have been discussed primarily in the consumer context, it should be understood that these systems and methods may be employed by any entity that has made a stream of payments, including businesses.

It will be apparent to those of skill in the art that numerous variations in addition to those discussed above are also possible. Therefore, while the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A system for verifying and reporting payment data, the system comprising:
a user terminal;
a payment data repository terminal connected to the user terminal;
a payment data database connected to the payment data repository terminal;
a verifier terminal connected to the payment data repository terminal; and
a recipient terminal connected to the payment data repository terminal;
wherein the payment data repository terminal is configured to perform the steps of
receiving from a user via the user terminal a request for verification of a plurality of payments in a stream of payments, the request including an identification of a payee to whom the payments were made;
transmitting to a verifier via the verifier terminal the request for verification of the plurality of payments and the identification of the payee;
receiving from the verifier an indication that the payments have been verified through contact with the payee;
storing an indication of the verification in the payment data database; and
outputting a verification report to a recipient via the recipient terminal;
wherein the user has no knowledge of an identity of the verifier when the request for verification is made.

2. The system of claim 1, wherein the payment data repository terminal is further configured to perform the step of:
receiving an identification of an authorized recipient from the user;
wherein the payment data repository terminal only outputs the report to a recipient corresponding to the identification received from the user.

3. The system of claim 1, wherein the payment data repository terminal is further configured to perform the steps of:
receiving from the user an authorization authorizing the third party to provide information by which the payment data can be verified to the verifier; and
transmitting the authorization to the verifier.

4. The system of claim 1, wherein the verifier is a member of the National Credit Reporting Association (NCRA) or a Fair Credit Reporting Act (FCRA)-certified specialist.

5. The system of claim 1, wherein the recipient uses the report for a permitted use as defined by the Fair Credit Reporting Act.

6. The system of claim 1, wherein the recipient uses the report in order to determine whether or not to extend credit to the user.

7. The system of claim 1, wherein the recipient is selected from the group consisting of an employer, an insurance company, and a lender.

8. The system of claim 1, wherein the payment data repository terminal is further configured to perform the step of:
storing data in the payment data database indicating a date on which each of the plurality of payments was due and an amount due for each such payment.

9. The system of claim 8, wherein the payment data repository terminal is further configured to perform the steps of:
comparing the amount of each payment made by the user to a corresponding amount due for each such payment;
comparing the date on which each payment was made by the user to a corresponding date on which each payment was due;
calculating a score based at least in part on a result of the comparing steps; and
including the score in the report.

10. The system of claim 8, wherein the payment data repository terminal is further configured to perform the step of reporting to the recipient a date on which each of the plurality of payments made by the user was due and an amount due for each such payment.

11. The system of claim 1, wherein payment data repository terminal is further configured to perform the steps of:
receiving from the user via the user terminal verification documents evidencing payment data for some or all of the plurality of payments, the payment data including a date on which the payment was made and an amount of the payment; and
transmitting the verification documents to the verifier.

12. A method for verifying and reporting payment data, the method comprising:
receiving a request from a user for verification of a plurality of payments in a stream of payments, the request including an identification of a payee to whom the plurality of payments were made;
transmitting the request and the identification of the payee to a verifier, without revealing an identity of the verifier to the user when the request is made;
receiving from the verifier an indication that the plurality of payments has been verified through contact with the payee;
storing an indication of the verification in a payment data database; and
communicating a report including an indication of the verification to a recipient;
wherein the user has no knowledge of an identity of the verifier when the request for verification has been made.

13. The method of claim 12 further comprising the step of:
receiving an identification of an authorized recipient from the user;
wherein the indication is only communicated to a recipient corresponding to the identification received from the user.

14. The method of claim 12, further comprising the steps of:
receiving an authorization from the user authorizing the third party to provide to the verifier information by which the payment data can be verified; and
transmitting the authorization to the verifier.

15. The method of claim 12, wherein the verifier is a member of the NCRA or an FCRA-certified specialist.

16. The method of claim 12, wherein the recipient uses the indication for a permitted use as defined by the Fair Credit Reporting Act.

17. The method of claim 12, wherein the recipient uses the indication to determine whether or not to extend credit to the user.

18. The method of claim 12, wherein the recipient is selected from the group consisting of an employer, an insurance company, and a lender.

19. The method of claim 12, further comprising the step of:
storing data in the payment data database indicating a date on which each of the plurality of payments was due and an amount due for each such payment.

20. The method of claim 19, further comprising the steps of:
comparing the amount of each payment made by the user to a corresponding amount due for each such payment;
comparing the date on which each payment was made by the user to a corresponding date on which each payment was due,
calculating a score based at least in part on a result of the comparing steps; and
outputting the score to the recipient.

21. The method of claim 19, further comprising the steps of reporting to the recipient a date on which each of the plurality of payments made by the user was due and an amount due for each such payment.

22. The method of claim 12, further comprising the steps of:
receiving verification documents relating to the plurality of payments from the user, the verification documents evidencing payment data for each payment in the plurality of payments, the payment data including a date on which the payment was made and an amount of the payment; and
transmitting the verification documents to the verifier.
